(19) United States
(12) Patent Application Publication
(10) Pub. No.: US 2013/0259276 A1
(43) Pub. Date: Oct. 3, 2013

(54) EARPHONE JACK AND EARPHONE INTERFACE CIRCUIT AND ELECTRONIC DEVICE

(71) Applicants: HONG FU JIN PRECISION INDUSTRY (SHENZHEN) CO., LT, Shenzhen (CN); HON HAI PRECISION INDUSTRY CO., LTD., New Taipei (TW)

(72) Inventor: ZHEN-JI XU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/693,063

(22) Filed: Dec. 4, 2012

(30) Foreign Application Priority Data
Apr. 2, 2012 (CN) 201210095513.6

(51) Int. Cl. H04R 5/033

(52) U.S. Cl. CPC H04R 5/033
USPC 381/309

(57) ABSTRACT

An earphone jack includes a left channel audio terminal for receiving a left audio channel signal, a right channel audio terminal for receiving a right audio channel signal, a first detecting terminal, a second detecting terminal, and an anti-interference unit connected between the first detecting terminal and the second detecting terminal. When the earphone plug is not received in a connecting hole of the earphone jack, the first detecting terminal is electrically connected to the right channel audio terminal, the second detecting terminal is electrically connected to the left channel audio terminal, the anti-interference unit prevents the left audio channel signal from being transmitted to the right channel audio terminal and prevents the right audio channel signal from being transmitted to the left channel audio terminal; and the first detecting terminal outputs an electrical signal for indicating that the earphone plug is not plugged into the earphone jack.

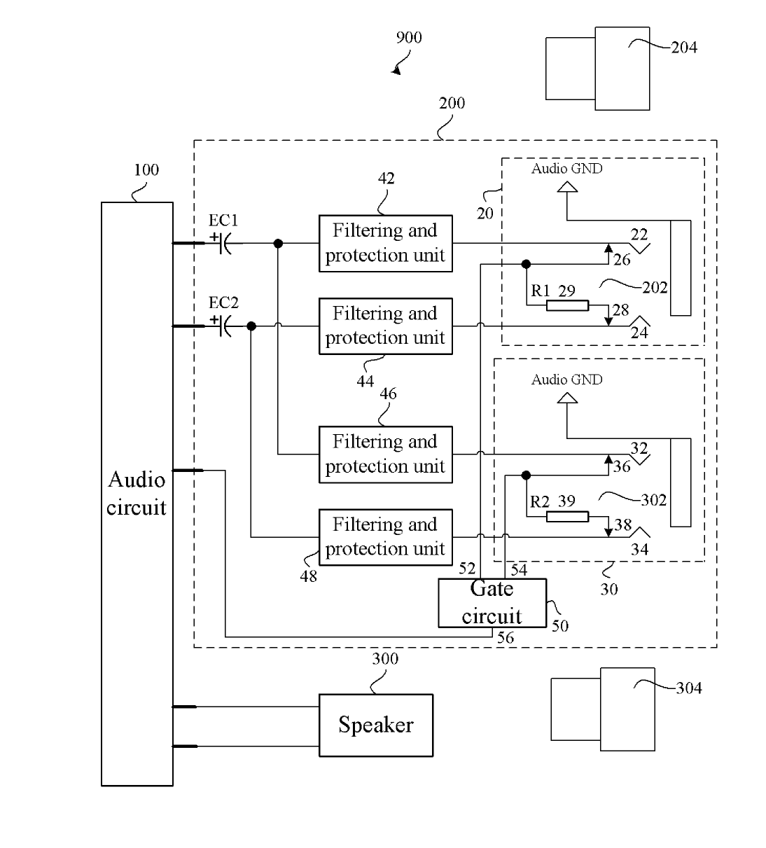

### BACKGROUND

1. Technical Field

The disclosed embodiments relate to an earphone jack, an earphone interface circuit, and an electronic device.

2. Description of Related Art

Electronic devices include an audio circuit and an earphone jack. The audio circuit provides a left audio channel signal and a right audio channel signal to the earphone jack. When an earphone plug of an earphone is plugged into the earphone jack, the left audio channel signal and the right audio channel signal are transmitted to the earphone for reproducing audio.

However, when the audio circuit outputs the left audio channel signal and the right audio channel signal to the earphone jack, the left audio channel signal may interfere with the right audio channel signal in the earphone jack.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout one view.

The figure is a circuit diagram of an electronic device in accordance with one embodiment.

### DETAILED DESCRIPTION

Referring to the figure, an electronic device 900 includes an audio circuit 100, an earphone interface circuit 200, and a speaker 300. The audio circuit 100 provides a left audio channel signal and a right audio channel signal. The earphone interface circuit 200 includes a first electrolytic capacitor EC1, a second electrolytic capacitor EC2, filtering and protection units 42, 44, 46, 48, a first earphone jack 20, a second earphone jack 30, and a gate circuit 50.

An anode of the first electrolytic capacitor EC1 receives the right audio channel signal, and a cathode of the first electrolytic capacitor EC1 is connected to the filtering and protection unit 42, 46. The first electrolytic capacitor EC1 filters a direct current (DC) portion of the right audio channel signal, and provides a first filtered right audio channel signal to the filtering and protection unit 42, 46. The filtering and protection unit 42, 46 filter noise in the first filtered right audio channel signal, provide an over-current protection and an ESD protection for the earphone interface circuit 200, and output a second filtered right audio channel signal to the first earphone jack 20 and the second earphone jack 30.

An anode of the second electrolytic capacitor EC2 receives the left audio channel signal, and a cathode of the second electrolytic capacitor EC2 is connected to the filtering and protection unit 44, 48. The second electrolytic capacitor EC2 filters a direct current portion of the left audio channel signal, and provides a first filtered left audio channel signal to the filtering and protection unit 44, 48. The second electrolytic capacitor EC2 filters a direct current portion of the left audio channel signal, and provides a first filtered left audio channel signal to the filtering and protection unit 42, 46. The filtering and protection unit 42, 46 filter noise in the first filtered left audio channel signal, provide an over-current protection and an ESD protection for the earphone interface circuit 200, and output a second filtered left audio channel signal to the first earphone jack 20 and the second earphone jack 30.

The first earphone jack 20 defines a first connecting hole 202 for receiving a first earphone plug 204. The first earphone jack 20 includes a first right channel audio terminal 22, a first left channel audio terminal 24, a first detecting terminal 26, a second detecting terminal 28, and a first anti-interference unit 29. The first right channel audio terminal 22 receives the second filtered right audio channel signal from the filtering and protection unit 42, and the first left channel audio terminal 24 receives the second filtered left audio channel signal from the filtering and protection unit 44. The first anti-interference unit 29 is connected between the first detecting terminal 26 and the second detecting terminal 28.

When the first earphone plug 204 is not plugged into the first connecting hole 202, the first detecting terminal 26 is electrically connected to the first right channel audio terminal 22, the second detecting terminal 28 is electrically connected to the first left channel audio terminal 24, the first anti-interference unit 29 prevents the left audio channel signal from being transmitted to the first right channel audio terminal 22 and prevents the right audio channel signal from being transmitted to the first left channel audio terminal 24, therefore the crosstalk between the first right channel audio terminal 22 and first left channel audio terminal 24 is effectively prevented. The first detecting terminal 26 outputs the first electrical signal for indicating that the first earphone plug 204 is not plugged into the first earphone jack 20. In this embodiment, the first anti-interference unit 29 is a first resistor R1, the resistance of the first resistor R1 is larger than 1KΩ. In other embodiments, the resistance of the first resistor R1 is equal to 1KΩ.

When the first earphone plug 204 is plugged into the first connecting hole 202, the first detecting terminal 26 is disconnected from the first right channel audio terminal 22, the second detecting terminal 28 is disconnected from the first left channel audio terminal 24.

The second earphone jack 30 defines a second connecting hole 302 for receiving a second earphone plug 304. The second earphone jack 30 includes a second right channel audio terminal 32, a second left channel audio terminal 34, a third detecting terminal 36, a fourth detecting terminal 38, and a second anti-interference unit 39. The second right channel audio terminal 32 receives the second filtered right audio channel signal from the filtering and protection unit 46, and the second left channel audio terminal 34 receives the second filtered left audio channel signal from the filtering and protection unit 48. The second anti-interference unit 39 is connected between the third detecting terminal 36 and the fourth detecting terminal 38.

When the second earphone plug 304 is not plugged into the second connecting hole 302, the third detecting terminal 36 is electrically connected to the second right channel audio terminal 32, the fourth detecting terminal 38 is electrically connected to the second left channel audio terminal 34, the second anti-interference unit 39 prevents the second filtered left audio channel signal from being transmitted to the second right channel audio terminal 32 and prevents the second filtered right audio channel signal from being transmitted to the second left channel audio terminal 34, therefore the crosstalk between the second right channel audio terminal 32 and the second left channel audio terminal 34 is effectively prevented. The third detecting terminal 36 outputs the second electrical signal for indicating that the second earphone plug 304 is not plugged into the second earphone jack 30. In this embodiment, the second anti-interference unit 39 is a second resistor R2, the resistance of the second resistor R2 is larger than 1KΩ. In other embodiments, the resistance of the second resistor R2 is equal to 1KΩ.

When the second earphone plug 304 is plugged into the second connecting hole 302, the third detecting terminal 36 is disconnected from the second right channel audio terminal 32, and the fourth detecting terminal 38 is disconnected from the second left channel audio terminal 34.

The gate circuit 50 includes a first input terminal 52 connected to the first detecting terminal 26, a second input terminal 54 connected to the third detecting terminal 36, and an output terminal 56 connected to the audio circuit 100. The output terminal 56 of the gate circuit 50 outputs a third electrical signal for indicating that the first earphone plug 204 is not plugged into the first earphone jack 20 and the second earphone plug 304 is not plugged into the second earphone jack 30 when the first input terminal 52 receives the first electrical signal and the second input terminal 54 receives the second electrical signal.

The audio circuit 100 outputs the left audio channel signal and the right audio channel signal to the speaker 300 in response to the third electrical signal.

Due to the function of the first anti-interference unit 29 and the second anti-interference unit 39, the left audio channel signal does not interfere with the right audio channel signal in the first earphone jack 20, and the left audio channel signal does not interfere with the right audio channel signal in the second earphone jack 30, it is beneficial for the electronic device 900.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An earphone jack defining a connecting hole for receiving an earphone plug, the earphone jack comprising:
a left channel audio terminal for receiving a left audio channel signal;
a right channel audio terminal for receiving a right audio channel signal;
a first detecting terminal;
a second detecting terminal; and
an anti-interference unit connected between the first detecting terminal and the second detecting terminal;
wherein when the earphone plug is not received in the connecting hole, the first detecting terminal is electrically connected to the right channel audio terminal, the second detecting terminal is electrically connected to the left channel audio terminal, the anti-interference unit prevents the left audio channel signal from being transmitted to the right channel audio terminal and prevents the right audio channel signal from being transmitted to the left channel audio terminal; and the first detecting terminal outputs an electrical signal for indicating that the earphone plug is not plugged into the earphone jack.

2. The earphone jack of claim 1, wherein when the earphone plug is received in the connecting hole, the first detecting terminal is disconnected from the right channel audio terminal, the second detecting terminal is disconnected from the left channel audio terminal

3. The earphone jack of claim 1, wherein the anti-interference unit comprises a resistor, one end of the resistor is connected to the first detecting terminal, the other end of the resistor is connected to the second detecting terminal

4. The earphone jack of claim 3, wherein the resistance of the resistor is larger than 1KΩ.

5. The earphone jack of claim 3, wherein the resistance of the resistor is equal to 1KΩ.

6. An earphone interface circuit, comprising:
a first earphone jack receiving a right audio channel signal and a left audio channel signal and defining a first connecting hole for receiving a first earphone plug and outputting a first electrical signal when the first earphone plug is not received in the first connecting hole, wherein the first earphone jack comprises a first anti-interference unit that prevents crosstalk between the right audio channel signal and the left audio channel signal;
a second earphone jack receiving the right audio channel signal and the left audio channel signal and defining a second connecting hole for receiving a second earphone plug and outputting a second electrical signal when the second earphone plug is not received in the second connecting hole, wherein the second earphone jack comprises a second anti-interference unit that prevents crosstalk between the right audio channel signal and the left audio channel signal; and
a gate circuit comprising a first input terminal connected to the first earphone jack, a second input terminal connected to the second earphone jack, and an output terminal, wherein the output terminal of the gate circuit outputs a third electrical signal for indicating that the first earphone plug is not plugged into the first earphone jack and the second earphone plug is not plugged into the second earphone jack when the first input terminal receives the first electrical signal and the second input terminal receives the second electrical signal.

7. The earphone interface circuit of claim 6, wherein the first earphone jack comprises:
a first left channel audio terminal for receiving a left audio channel signal;
a first right channel audio terminal for receiving a right audio channel signal;
a first detecting terminal;
a second detecting terminal; and
a first anti-interference unit connected between the first detecting terminal and the second detecting terminal; when the first earphone plug is not received in the first connecting hole, the first detecting terminal is electrically connected to the first right channel audio terminal, the second detecting terminal is electrically connected to the first left channel audio terminal, the first anti-interference unit prevents the left audio channel signal from being transmitted to the first right channel audio terminal and prevents the right audio channel signal from being transmitted to the first left channel audio terminal; and the first detecting terminal outputs the first electrical signal for indicating that the first earphone plug is not plugged into the first earphone jack; and
the second earphone jack comprises:
a second left channel audio terminal for receiving the left audio channel signal;
a second right channel audio terminal for receiving the right audio channel signal;
a third detecting terminal;
a fourth detecting terminal; and
a second anti-interference unit connected between the third detecting terminal and the fourth detecting terminal; when the second earphone plug is not received in the second connecting hole, the third detecting terminal is electrically connected to the second right channel audio terminal, the fourth detecting terminal is electrically connected to the second left channel audio terminal, the second anti-interference unit prevents the left audio channel signal from being transmitted to the second right channel audio terminal and prevents the right audio channel signal from being transmitted to the second left channel audio terminal; and the third detecting terminal outputs the second electrical signal for indicating that the second earphone plug is not plugged into the second earphone jack.

8. The earphone interface circuit of claim 7, wherein when the first earphone plug is received in the first connecting hole, the first detecting terminal is disconnected from the first right channel audio terminal, the second detecting terminal is disconnected from the first left channel audio terminal; when the second earphone plug is received in the second connecting hole, the third detecting terminal is disconnected from the second right channel audio terminal, the fourth detecting terminal is disconnected from the second left channel audio terminal

9. The earphone interface circuit of claim 7, further comprising a first electrolytic capacitor and a second electrolytic capacitor, wherein an anode of the first electrolytic capacitor receives the right audio channel signal, the cathode of the first electrolytic capacitor is connected to the first right channel audio terminal and the second right channel audio terminal;
an anode of the second electrolytic capacitor receives the left audio channel signal, the cathode of the second electrolytic capacitor is connected to the first left channel audio terminal and the second left channel audio terminal.

10. The earphone interface circuit of claim 7, wherein the first anti-interference unit comprises a first resistor, one end of the first resistor is connected to the first detecting terminal, the other end of the first resistor is connected to the second detecting terminal;
the second anti-interference unit comprises a second resistor, one end of the second resistor is connected to the third detecting terminal, the other end of the second resistor is connected to the fourth detecting terminal.

11. The earphone interface circuit of claim 10, wherein the resistance of the first resistor is larger than 1KΩ, the resistance of the second resistor is larger than 1KΩ.

12. The earphone interface circuit of claim 10, wherein the resistance of the first resistor is equal to 1KΩ, the resistance of the second resistor is equal to 1KΩ.

13. An electronic device, comprising:
an audio circuit providing a left audio channel signal and a right audio channel signal;
a first earphone jack receiving the right audio channel signal and the left audio channel signal and defining a first connecting hole for receiving a first earphone plug and Page 11 of 16 outputting a first electrical signal when the first earphone plug is not received in the first connecting hole, wherein the first earphone jack comprises a first anti-interference unit that prevents crosstalk between the right audio channel signal and the left audio channel signal;
a second earphone jack receiving the right audio channel signal and the left audio channel signal and defining a second connecting hole for receiving a second earphone plug and outputting a second electrical signal when the second earphone plug is not received in the second connecting hole, wherein the second earphone jack comprises a second anti-interference unit that prevents crosstalk between the right audio channel signal and the left audio channel signal; and
a gate circuit comprising a first input terminal connected to the first earphone jack, a second input terminal connected to the second earphone jack, and an output terminal, wherein the output terminal of the gate circuit outputs a third electrical signal for indicating that the first earphone plug is not plugged into the first earphone jack and the second earphone plug is not plugged into the second earphone jack when the first input terminal receives the first electrical signal and the second input terminal receives the second electrical signal.

14. The electronic device of claim 13, further comprising a speaker, wherein the audio circuit outputs the left audio channel signal and the right audio channel signal to the speaker in response to the third electrical signal.

15. The electronic device of claim 13, wherein the first earphone jack comprises:
a first left channel audio terminal for receiving a left audio channel signal;
a first right channel audio terminal for receiving a right audio channel signal;
a first detecting terminal;
a second detecting terminal; and
a first anti-interference unit connected between the first detecting terminal and the second detecting terminal; when the first earphone plug is not received in the first connecting hole, the first detecting terminal is electrically connected to the first right channel audio terminal, the second detecting terminal is electrically connected to the first left channel audio terminal, the first anti-interference unit prevents the left audio channel signal from being transmitted to the first right channel audio terminal and prevents the right audio channel signal from being transmitted to the first left channel audio terminal; and the first detecting terminal outputs the first electrical signal for indicating that the first earphone plug is not plugged into the first earphone jack; and
the second earphone jack comprises:
a second left channel audio terminal for receiving the left audio channel signal;
a second right channel audio terminal for receiving the right audio channel signal;
a third detecting terminal;
a fourth detecting terminal; and
a second anti-interference unit connected between the third detecting terminal and the fourth detecting terminal; when the second earphone plug is not received in the second connecting hole, the third detecting terminal is electrically connected to the second right channel audio terminal, the fourth detecting terminal is electrically connected to the second left channel audio terminal, the second anti-interference unit prevents the left audio channel signal from being transmitted to the second right channel audio terminal and prevents the right audio channel signal from being transmitted to the second left channel audio terminal; and the third detecting terminal outputs the second electrical signal for indicating that the second earphone plug is not plugged into the second earphone jack.

16. The electronic device of claim 15, wherein when the first earphone plug is received in the first connecting hole, the first detecting terminal is disconnected from the first right channel audio terminal, the second detecting terminal is disconnected from the first left channel audio terminal; when the second earphone plug is received in the second connecting hole, the third detecting terminal is disconnected from the second right channel audio terminal, the fourth detecting terminal is disconnected from the second left channel audio terminal

17. The electronic device of claim 15, further comprising a first electrolytic capacitor and a second electrolytic capacitor, wherein an anode of the first electrolytic capacitor receives the right audio channel signal, the cathode of the first electrolytic capacitor is connected to the first right channel audio terminal and the second right channel audio terminal;
an anode of the second electrolytic capacitor receives the left audio channel signal, the cathode of the second electrolytic capacitor is connected to the first left channel audio terminal and the second left channel audio terminal.

18. The electronic device of claim 15, wherein the first anti-interference unit comprises a first resistor, one end of the first resistor is connected to the first detecting terminal, the other end of the first resistor is connected to the second detecting terminal; the second anti-interference unit comprises a second resistor, one end of the second resistor is connected to the third detecting terminal, the other end of the second resistor is connected to the fourth detecting terminal

19. The electronic device of claim 15, wherein the resistance of the first resistor is larger than 1KΩ, the resistance of the second resistor is larger than 1KΩ.

20. The electronic device of claim 15, wherein the resistance of the first resistor is equal to 1KΩ, the resistance of the second resistor is equal to 1KΩ.
